(19) United States
(12) Patent Application Publication
(10) Pub. No.: US 2006/0257653 A1
(43) Pub. Date: Nov. 16, 2006

(54) Laser-markable fibers or fiber products

(76) Inventors: Yutaka Tsujimoto, Hyogo (JP); Yoshiaki Sakai, Nara (JP); Frédéric Loyrion, Cedex (FR)

Correspondence Address: FITCH, EVEN, TABIN & FLANNERY, P. O. BOX 65973, WASHINGTON, DC, 20035, US

(21) Appl. No.: 10/556,378

(22) PCT Filed: May 14, 2004
(86) PCT No.: PCT/JP04/06864

§ 371 Date: Jan. 24, 2006

(30) Foreign Application Priority Data
May 14, 2003 (JP) 2003-136426

(51) Int. Cl. D01F 1/02; D02G 3/00; H05B 6/00

(52) U.S. Cl. 428/364; 264/211; 264/482; 428/372

(57) ABSTRACT

The present invention provides a fiber or fiber product comprising an artificial fiber and filler incorporated therein, the filler being a filler whose own color changes or a filler mixture whose entire color appears to change by irradiation with a laser beam. The filler whose own color changes by irradiation with a laser beam is preferably barium sulfate or diantimony. The filler is usually in the form of particles with a mean particle diameter of not more than about 15 μm. When the fiber or fiber product of the invention is irradiated with a laser beam, the fiber changes color in the irradiated portion, so that a minute mark can be produced on the individual spun yarns or filament yarns of the fiber or fiber product.

### TECHNICAL FIELD

The present invention relates to a laser-markable fiber or fiber product.

### BACKGROUND ART

Methods generally used for marking a fiber or fiber product with a pattern or a mark such as a letter or symbol include printing the fiber or fiber product using a dye, pigment or the like; and printing on the fiber or fiber product using an inkjet printer, etc. (see, for example, Japanese Unexamined Patent Publications Nos. 1990-41480 and 1995-336466).

However, the above methods can not be used to produce minute marks such as letters or symbols on fibers or fiber products. Therefore, it has been impossible to mark individual yarns with such marks.

### DISCLOSURE OF THE INVENTION

An object of the invention is to provide a fiber or fiber product wherein the individual yarns can be marked with minute marks. In this specification, “individual yarns” include spun yarns, monofilament yarns, multifilament yarns and composite yarns thereof.

The present inventors carried out intensive research to develop a fiber or fiber product wherein the individual yarns can be marked with a minute mark, such as letters or symbols. As a result, the inventors found that a fiber or fiber product that achieves the above object can be produced by kneading into an artificial fiber a filler whose own color changes or a filler mixture whose entire color appears to change by irradiation with a laser beam. The present invention has been accomplished based on this finding.

The invention provides the following fibers, fiber products and methods:

1. A fiber or fiber product comprising an artificial fiber and a filler incorporated therein, the filler being a filler whose own color changes or a filler mixture whose entire color appears to change by irradiation with a laser beam.

2. A fiber or fiber product according to item 1 wherein the filler whose own color changes by irradiation with a laser beam is at least one member selected from the group consisting of mica, barium sulfate, zinc sulfide, diantimony trioxide, copper phosphate and tocopherols.

3. A fiber or fiber product according to item 1 wherein the filler mixture whose entire color appears to change by irradiation with a laser beam is a mixture of the filler whose own color changes by irradiation with a laser beam and a white pigment or a mixture of a white filler and a black pigment.

4. A fiber or fiber product according to item 3 wherein the white pigment is titanium dioxide.

5. A fiber or fiber product according to item 3 wherein the black pigment is a carbon black.

6. A fiber or fiber product according to item 3 wherein the white filler is barium sulfate.

7. A fiber or fiber product according to item 1 wherein the filler is in an amount of about 0.01 to about 10 wt. %, relative to the total weight of artificial fiber and filler.

8. A fiber or fiber product according to item 1 wherein the filler is in the form of particles with a mean particle diameter of not more than about 15 μm.

9. A fiber or fiber product according to item 1 wherein the artificial fiber is a polyester.

10. A method of producing an artificial fiber containing a filler whose own color changes or a filler mixture whose entire color appears to change by irradiation with a laser beam, comprising:
mixing and dispersing the filler in a melt or solution of the artificial fiber raw material; and
spinning the dispersion into a fiber.

11. A method of marking a fiber or fiber product with a mark or pattern, comprising irradiating with a laser beam the fiber or fiber product of any of items 1 to 9.

12. A method of distinguishing whether a fiber or fiber product is marked or unmarked, comprising checking for the presence of a mark or pattern marked on the fiber or fiber product of any of items 1 to 9.

### FIBERS OR FIBER PRODUCTS OF THE INVENTION

The fiber or fiber product of the invention comprises an artificial fiber and a filler incorporated therein. The filler is a filler whose own color changes or a filler mixture whose entire color appears to change by irradiation with a laser beam.

Any of a wide variety of known artificial fibers can be used as the artificial fiber of the invention so long as a filler whose own color changes or a filler mixture whose entire color appears to change by irradiation with a laser beam can be incorporated thereinto. Examples of such artificial fibers include synthetic fibers, semi-synthetic fibers, regenerated fibers, inorganic fibers and the like.

Examples of usable synthetic fibers include polyesters, aliphatic polyamides, aromatic polyamides, polyethylenes, polypropylenes, vinylons, acrylics, polyvinyl alcohols, polyurethanes and the like.

Examples of usable semi-synthetic fibers include acetates, triacetates, promix and the like.

Examples of usable regenerated fibers include rayon, cupra and the like.

Examples of usable inorganic fibers include carbon fibers, ceramic fibers and the like.

Among the artificial fibers, synthetic fibers are preferable, and polyesters are more preferable. Specific examples of polyesters include polyethylene terephthalate, polytrimethylene terephthalate, polytetramethylene terephthalate and the like.

Examples of artificial fibers include slit yarns produced by slitting a plastic film such as polyethylene terephthalate, polyethylene or polypropylene. Such slit yarns usually have a width of about 0.1 to about 0.8 mm, and preferably about 0.15 to about 0.37 mm; and usually have a thickness of about 20 μm or less, and preferably about 2 to about 12 μm.

The artificial fibers of the invention may be used singly or spun, plied or twisted together.

The artificial fibers may have a core-sheath structure. Examples of artificial fibers with a core-sheath structure include those produced by using a slit yarn as a core and winding another fiber (spun yarn or filament yarn) therearound, those produced by using a spun yarn or filament yarn as a core and winding a slit yarn therearound and those comprising a monofilament yarn with an internal core-sheath structure.

The artificial fibers may have a uniform or non-uniform thickness. The cross section of artificial fibers may have any shape such as circular, elliptical, Y-shaped, cross-shaped, W-shaped, L-shaped, T-shaped, hollow, triangular, flat, star-shaped, cocooned, eight-leaved, dog-bone shaped (or dumbbell), etc.

The fiber of the invention includes not only these fibers but also primary processed products thereof, such as yarns, knits, woven fabrics, knitted fabrics, nonwoven fabrics and the like.

The artificial fiber of the invention may be a blend fabric blended with natural fibers such as cellulose fibers, animal hair fibers, silks and the like.

In this specification, a “fiber product” refers to a product obtained by further processing of a fiber. Examples of such products include outer garments, intermediate garments, innerwear and like clothing, beds and bedroom accessories, interior accessories and the like. Specific examples of fiber products of the invention include clothing such as coats, jackets, trousers, skirts, shirts, knitted shirts, blouses, sweaters, cardigans, nightwear, underwear, supporters, socks, tights, hats, scarves, mufflers, gloves, garment linings, garment stiffeners, cotton stuffing for clothes, work clothing, sanitary gowns, uniforms, prison uniforms, schoolchildren's uniforms and the like; beds and bedroom accessories such as mattress coverings, wadding cotton, pillow cases, sheets and the like; interior accessories such as curtains, mats, carpets, cushions, stuffed toys and the like; fancy goods such as towels, handkerchieves and the like; yarn products such as machine sewing threads, embroidery threads, plaited cords, straps, braids, fishing lines and artificial baits; tags on merchandise; paper products or nonwoven fabrics; bags; materials for electronic products and construction materials.

Specific examples of paper products include securities such as stocks, national bonds, local bonds, gift vouchers, drafts, checks, postage stamps, revenue stamps, certificate stamps and admission tickets; vouchers such as coupons and public lottery tickets; paper currency; various kinds of certificate forms, and the like.

Examples of the filler whose own color changes by irradiation with a laser beam are mica, barium sulfate (BaSO₄), zinc sulfide (ZnS), diantimony trioxide (Sb₂O₃), copper phosphate (Cu₃(PO₄)₂), tocopherols, lithopone and the like. These fillers can be used singly or in combination of two or more. Among them, barium sulfate and diantimony trioxide are preferable.

Tocopherols (vitamin E) include α-tocopherol and β-tocopherol.

Glimmer pigments containing mica can preferably be used as mica. Such glimmer pigments are sold, for example, by Merck under the trade name of Iriodin LS.

The filler is preferably in the form of particles. The mean particle diameter is usually not more than about 15 μm, and preferably not more than about 1 μm. The particle diameter can be measured by, for example, laser diffraction methods.

Examples of the filler mixture whose entire color appears to change by irradiation with a laser beam are a mixture of a filler whose own color changes by irradiation with a laser beam and a white pigment, a mixture of a white filler and a black pigment, etc.

Of these fillers, mica, zinc sulfide, diantimony trioxide and tocopherols are preferable as fillers that change color from white to black.

These fillers can be used in combination with a white pigment that acts as a white basis in a fiber. The entire color of such a mixture of a filler and a white pigment changes color from white to black.

Examples of white pigments include calcium carbonate, titanium dioxide (titanium white), zinc oxide and the like. A preferable white pigment is titanium dioxide. Such white pigments can be used singly or in combination of two or more.

The mean particle diameter of white pigment is usually selected from a wide range of about 10 nm to about 3 μm, and preferably about 10 nm to about 1 μm.

The white pigment is usually used in an amount of about 5 to about 90 wt. %, and preferably about 10 to about 70 wt. %, relative to the weight of filler whose own color changes by irradiation with a laser beam.

In case the filler whose own color changes by irradiation with a laser beam is a white filler, the white filler can be used in combination with a black pigment that acts as a black basis in a fiber. The entire color of the mixture of the white filler and black pigment changes from black to white due to the phase separation of the black pigment, bubble formation and so on.

Examples of white fillers include mica, barium sulfate and the like. A preferable white filler is barium sulfate. Such white fillers can be used singly or in combination of two or more.

Examples of usable black pigments include carbon blacks (acetylene black, lamp black, thermal black, furnace black, channel black, Ketjenblack, etc.), graphite, titanium black, black iron oxide and the like. Among these, carbon blacks are preferable in view of dispersibility and cost. Such black pigments can be used singly or in combination of two or more. Carbon blacks can be classified into acetylene black, oil black, gas black, etc. according to the raw materials, and any carbon black can be used.

The mean particle diameter of black pigment is usually selected from a wide range of about 10 nm to about 3 μm, and preferably about 10 nm to about 1 μm. When the black pigment is a carbon black, it is preferable to have a mean particle diameter of about 10 to about 30 nm.

The amount of black pigment is usually in the range of about 0.1 to about 80 wt. %, and preferably about 10 to about 50 wt. %, relative to the weight of white filler.

The filler (the filler whose own color changes or filler mixture whose entire color appears to change by irradiation with a laser beam) is usually contained in the fiber or fiber product of the invention in an amount of about 0.01 to about 10 wt. %, preferably about 0.3 to about 3 wt. %, and more preferably about 0.6 to about 1.2 wt. %, relative to the total weight of artificial fiber and filler.

The fiber or fiber product of the invention may optionally contain other components such as known antimicrobial agents, UV absorbers, UV reflectors, colored (i.e., non-black, non-white) pigments and the like.

### METHOD OF PRODUCING THE FIBER OR FIBER PRODUCT OF THE INVENTION

The fiber of the invention comprising a filler whose own color changes or a filler mixture whose entire color appears to change by irradiation with a laser beam can be produced by kneading the filler into the fiber during the process of spinning the fiber raw material into a fiber. When the artificial fiber has a core-sheath structure, the filler may be kneaded into either or both its core and sheath.

The fiber of the invention is produced, for example, by mixing and dispersing in a melt or solution of the artificial fiber raw material a filler whose own color changes or a filler mixture whose entire color appears to change by irradiation with a laser beam, and then spinning the resulting dispersion into a fiber. The filler is preferably mixed and dispersed in the fiber raw material in the form of a masterbatch.

A wide variety of known spinning methods such as melt-spinning methods, dry-spinning methods and wet-spinning methods can be used as the spinning method. Which spinning method is used depends on the kind of fiber raw material used.

When the fiber raw material can be melted in a thermally and chemically stable manner, it is preferable to use melt-spinning. In this case, a predetermined amount of filler may be mixed and dispersed in the melt of the fiber raw material. The fiber of the invention can be produced by ejecting the fiber raw material melt with a filler mixed and dispersed therein through a fine nozzle into the air, followed by air cooling and solidifying the molten filament while attenuating and then drawing it out at a constant speed. Fibers suited to melt-spinning are, for example, polyesters, aliphatic polyamides, polyethylenes and polypropylenes.

When the fiber raw material is stable at high temperatures and can dissolve in a volatile solvent, it is preferable to use dry-spinning. In this case, a predetermined amount of filler may be mixed and dispersed in a volatile solvent solution of the fiber raw material. The fiber of the invention can be produced by ejecting the fiber raw material solution with a filler mixed and dispersed therein through a fine nozzle into a heated gas and then solidifying the solution into a fiber while evaporating the volatile solvent. Fibers suited to dry-spinning are acrylics, acetates, and the like.

When the fiber raw material dissolves only in low volatility solvents or solvents unstable at high temperatures, it is preferable to use wet-spinning. In this case, a predetermined amount of filler may be mixed and dispersed in a solution of the fiber raw material. The fiber of the invention can be produced by ejecting the fiber raw material solution with a filler mixed and dispersed therein through a fine nozzle into a coagulation bath containing a nonsolvent, and then solidifying it into a fiber while removing the solvent. Fibers suited to wet-spinning are, for example, polyvinyl alcohols and rayon.

When the fiber of the invention is in the form of slit yarns, it can be produced by slitting the following plastic films or multi-layered films using a cutter such as a micro slitter, tape slitter, etc.: a plastic film (e.g., polyethylene terephthalate, polyethylene, polypropylene, etc.) into which a filler whose own color changes or a filler mixture whose entire color appears to change by irradiation with a laser beam has been incorporated; a plastic film (e.g., polyethylene terephthalate, polyethylene, polypropylene, etc.) coated with a composition comprising a filler whose own color changes or a filler mixture whose entire color appears to change by irradiation with a laser beam; or multi-layered films produced by laminating other film(s) (e.g., polyethylene terephthalate) on the above plastic films.

Using a fiber of the invention produced by the above method, a fiber product of the invention can be produced by known methods such as sewing.

When the fiber product of the invention is a paper product, the paper product can be produced by scooping up the fiber produced by the above methods with a fine mesh screen.

Fibers or fiber products of the invention may be dyed using dyes or pigments appropriate to the fiber raw material.

### METHOD OF USING THE FIBER OR FIBER PRODUCT OF THE INVENTION

When the fiber or fiber product of the invention impregnated with a filler that changes color by irradiation with a laser beam or having such a filler attached thereto is irradiated with a laser, the filler changes color by laser beam irradiation. Therefore, it is possible to change the color of the fiber or fiber product only in the laser beam-irradiated portions.

When the filler incorporated in or attached to the fiber or fiber product of the invention is a mixture of a white filler and a black pigment, phase separation or other phenomena occur in the black pigment and the white pigment displays itself on the surface of the fiber or fiber product. As a result, it is possible to change the color of the fiber or fiber product only in the laser beam-irradiated portions.

Lasers-usable for the invention are YAG lasers, excimer lasers, CO₂ lasers and the like. Of these lasers, YAG lasers are preferable, and Nd-YAG lasers are more preferable.

There is no limitation on the wavelength of the laser so long as it changes the color of the filler. In the case of Nd-YAG lasers, it is preferable that the wavelength be about 354 nm, about 532 nm or about 1064 nm.

The fiber or fiber product of the invention can be irradiated, for example, by using a scanning laser marking device. Since the laser beam irradiation can be controlled by computer, a minute distinguishing mark (e.g., logos, code numbers, serial numbers, etc.) can be produced in a predetermined position on the fiber or fiber product.

Slit yarn marked with a mark or pattern can be used as an anti-counterfeiting thread for paper products such as those mentioned above. “Thread” as used herein includes ribbons of film or foil, wires and any other suitable elongate elements for inclusion in paper products.

Therefore, by checking for the presence of a mark or pattern marked on the fiber or fiber product, it can be distinguished whether the fiber or fiber product is marked or unmarked.

More specifically, the fiber or fiber product of the invention is irradiated with a laser beam to produce a fiber or fiber product with a mark or pattern thereon. Marketed fibers or fiber products can then be checked for the presence of the mark or pattern to distinguish whether the fibers or fiber products are authentic or counterfeit.

The above checking can be carried out with the naked eye, a magnifying glass, a microscope, etc.

### EFFECTS OF THE INVENTION

The invention provides fibers or fiber products wherein the individual yarns can be marked with a minute mark.

The invention also provides a method of producing fibers or fiber products wherein the individual yarns can be marked with a minute mark.

When the fiber or fiber product of the invention is irradiated with a laser beam, the irradiated portion changes color, so that marks such as letters, symbols or patterns can be produced on the fiber or fiber product. Since only the portion of the fiber of the invention irradiated with a laser beam changes color, individual yarns of the fiber product of the invention can be marked with marks, such as letters, symbols, etc.

Brand name products partially or entirely made of the fiber of the invention can be marked with a brand mark or pattern that cannot be distinguished by the naked eye but is distinguishable under a magnifying glass or a microscope, thereby allowing one to easily distinguish whether marketed products are authentic or counterfeit articles, and thus effectively preventing the counterfeiting of brand name products.

The fiber product of the invention has the advantage that the product when sold can quickly be marked with the purchaser's name, desired patterns, symbols, etc. in the store.

The fiber or fiber product of the invention is expected to find various applications such as an embroidery substitute.

### BEST MODE FOR CARRYING OUT THE INVENTION

The present invention will be described below in further detail with reference to Examples.

### EXAMPLE 1

A polyester masterbatch (trade name: CESAf LASER NB94120503, product of Clariant International Ltd.) containing 10 wt. % of barium sulfate (mean particle diameter: 1 μm) and 10 wt. % of carbon black was added in an amount of 5 wt. % to a molten polyester (polyethylene terephthalate) prepared by heating to 295° C., so that barium sulfate and carbon black were dispersed in the polyester to give a polyester melt.

The melt was then ejected through a nozzle into the air and the ejected molten filaments were stretched to three times their original length at 115° C., thus giving a polyester fiber (filament yarn, diameter: 100 μm) of the invention having barium sulfate and carbon black incorporated therein.

### EXAMPLE 2

A polyester masterbatch (trade name: CESAf LASER NB03120509, product of Clariant International Ltd.) containing 20 wt. % of diantimony trioxide (mean particle diameter: 1 μm) that changes from white to black by laser beam irradiation was added in an amount of 5 wt. % to a molten polyester (polyethylene terephthalate) prepared by heating to 295° C., so that diantimony trioxide was dispersed in the polyester to give a polyester melt.

The melt was ejected through a nozzle into the air and the molten filaments were stretched at 115° C. to three times their original length, thus giving a polyester fiber (filament yarn, diameter: 100 μm) of the invention having diantimony trioxide incorporated therein.

### EXAMPLE 3

A 6 μm-thick transparent biaxially stretched polyamide film was microslit to a width of 0.2 mm to give slit yarns.

Fibers of the invention having a core-sheath structure were produced by using the barium sulfate-containing polyester fiber (filament yarn) obtained in Example 1 as a core and wrapping the above slit yarn therearound.

### EXAMPLE 4

A 6 μm-thick transparent biaxially stretched polyamide film was microslit to a width of 0.2 mm to give slit yarns.

Fibers of the invention having a core-sheath structure were produced by using the diantimony trioxide-containing polyester fiber (filament yarn) obtained in Example 2 as a core and wrapping the above slit yarn therearound.

### EXAMPLE 5

The filament yarn obtained in Example 1 was partially irradiated with a Nd-YAG laser (wavelength: 532 nm). In the irradiated portions, phase separation occurred in the carbon black and barium sulfate displayed itself on the surface of the filament yarn. As a result, the portion irradiated with the laser changed from black to white, which was clearly distinguishable with the naked eye from the hue of the portions which had not been irradiated with the laser.

### EXAMPLE 6

The filament yarn obtained in Example 2 was partially irradiated with a Nd-YAG laser (wavelength: 532 nm). In the irradiated portions, diantimony trioxide changed from white to black, which was clearly distinguishable with the naked eye from the hue of the portions which had not been irradiated with the laser.

### EXAMPLE 7

The monofilament yarn obtained in Example 1 was irradiated with a Nd-YAG laser beam (wavelength: 1064 nm) using a scanning laser marking device (product of TAMPOPRINT AG, model number: WS+SK−86) to make alphabetical marks (letter size: 80 μm×80 μm).

The monofilament yarn was observed under a 200-times optical microscope. The alphabetical marks were clearly recognizable.

### EXAMPLE 8

The monofilament yarn obtained in Example 2 was irradiated with a Nd-YAG laser beam (wavelength: 1064 nm) using a scanning laser marking device (product of TAMPOPRINT AG, model number: WS+SK−86) to make alphabetical marks (letter size: 80 μm×80 μm).

The monofilament yarn was observed under a 200-fold optical microscope. The alphabetical marks were clearly recognizable.

1. A fiber or fiber product comprising an artificial fiber and a filler incorporated therein, the filler being a filler whose own color changes or a filler mixture whose entire color appears to change by irradiation with a laser beam.

2. A fiber or fiber product according to claim 1 wherein the filler whose own color changes by irradiation with a laser beam is at least one member selected from the group consisting of mica, barium sulfate, zinc sulfide, diantimony trioxide, copper phosphate and tocopherols.

3. A fiber or fiber product according to claim 1 wherein the filler mixture whose entire color appears to change by irradiation with a laser beam is a mixture of the filler whose own color changes by irradiation with a laser beam and a white pigment or a mixture of a white filler and a black pigment.

4. A fiber or fiber product according to claim 3 wherein the white pigment is titanium dioxide.

5. A fiber or fiber product according to claim 3 wherein the black pigment is a carbon black.

6. A fiber or fiber product according to claim 3 wherein the white filler is barium sulfate.

7. A fiber or fiber product according to claim 1 wherein the filler is in an amount of about 0.01 to about 10 wt. %, relative to the total weight of artificial fiber and filler.

8. A fiber or fiber product according to claim 1 wherein the filler is in the form of particles with a mean particle diameter of not more than about 15 μm.

9. A fiber or fiber product according to claim 1 wherein the artificial fiber is a polyester.

10. A method of producing an artificial fiber containing a filler whose own color changes or a filler mixture whose entire color appears to change by irradiation with a laser beam, comprising:
mixing and dispersing the filler in a melt or solution of the artificial fiber raw material; and
spinning the dispersion into a fiber.

11. A method of marking a fiber or fiber product with a mark or pattern, comprising irradiating with a laser beam the fiber or fiber product of claim 1.

12. A method of distinguishing whether a fiber or fiber product is marked or unmarked, comprising checking for the presence of a mark or pattern marked on the fiber or fiber product of claim 1.
